(19) United States
(12) Patent Application Publication
(10) Pub. No.: US 2004/0134375 A1
(43) Pub. Date: Jul. 15, 2004

(54) Solution composition and method for electroless deposition of coatings free of alkali metals

(76) Inventors: Artur Kolics, San Jose, CA (US); Nicolai Petrov, Santa Clara, CA (US); Chiu Ting, Saratoga, CA (US); Igor Ivanov, Dublin, CA (US)

Correspondence Address: MOLLIE E. LETTANG, CONLEY ROSE,P.C., P.O. 684908, AUSTIN,, TX, 78768-4908, US

(21) Appl. No.: 10/339,260

(22) Filed: Jan. 10, 2003

(51) Int. Cl. C23C 18/00; B05D 5/12

(52) U.S. Cl. 106/1.22; 106/1.26; 106/1.27; 106/1.24; 106/1.28; 427/123

(57) ABSTRACT

An electroless deposition solution of the invention for forming an alkali-metal-free coating on a substrate comprises a first-metal ion source for producing first-metal ions, a pH adjuster in the form of a hydroxide for adjusting the pH of the solution, a reducing agent, which reduces the first-metal ions into the first metal on the substrate, a complexing agent for keeping the first-metal ions in the solution, and a source of ions of a second element for generation of second-metal ions that improve the corrosion resistance of the aforementioned coating. The method of the invention consists of the following steps: preparing hydroxides of a metal such as Ni and Co by means of a complexing reaction, in which solutions of hydroxides of Ni and Co are obtained by displacing hydroxyl ions OH⁻ beyond the external boundary of ligands of mono- or polydental complexants; preparing a complex composition based on a tungsten oxide WO₃ or a phosphorous tungstic acid, such as H₃[P(W₃O₁₀)₄], as well as on the use of tungsten compounds for improving anti-corrosive properties of the deposited films; mixing the aforementioned solutions of salts of Co, Ni, or W and maintaining under a temperatures within the range of 20° C. to 100° C.; and carrying out deposition from the obtained mixed solution.

### FIELD OF THE INVENTION

The present invention relates to the field of electroless plating, in particular to solution compositions and a method for electroless formation of alkali-metal-free coatings on the basis of metals, such as cobalt and nickel and composition of these metal with tungsten and phosphorus, which have high resistance to oxidation. Such coating may find application in semiconductor manufacturing where properties of deposited films and controllability of the composition and physical and chemical characteristics of the deposited films may be critically important.

### BACKGROUND OF THE INVENTION

Copper is increasingly replacing aluminum in interconnects fabrication in ultra-large-scale (ULSI) microelectronic devices. Nevertheless, this technology faces few problems such as metal corrosion, weak adhesion, high chemical reactivity, and considerable diffusion of copper in silicon. One of the recent approaches to successfully address these issues is the formation of barrier/capping layer by electroless deposition. Thin films of Co(W,P) and Ni(Re,P) prepared by electroless deposition have already been shown to have potential application as the barrier/capping layers on copper interconnects. These films provide significantly lower resistivity than other barriers and the formation of very thin, selective, and conformal deposition can be achieved through the electroless deposition.

Several related deposition chemistries shown in Table 1 have been developed and published recently for depositing phosphorous-containing cobalt or nickel-based amorphous barriers.

TABLE 1

| Components | | | | | | | | | | |
|---|---|---|---|---|---|---|---|---|---|---|
| and operating | Concentration of components (g/l) | | | | | | | | | |
| conditions | Pat. 3*** | Pat. 2** | Pat. 1* | 4^{3κ}, 5^{4κ} | 2^{1κ}, 3^{2κ} | 1^{λ} | 8^{π} | | | 9^{θ} |
| Cobalt sulfate | | | | 23 | 23 | 23 | | | | 10-30 |
| heptahydrate | | | | | | | | | | |
| Cobalt | 30 | 4 | 30 | | | | 30-60 | 30-60 | 30-60 | |
| chloride hexahydrate | | | | | | | | | | |
| Sodium hypophosphite | 20 | 15 | 20 | 21 | 21 | 21 | 10-20 | | | |
| Ammonium | | | | | | | | | | 25-50 |
| hypophosphite | | | | | | | | | | |
| (TMA)H₂PO₂ | | | | | | | | 10-20 | 10-20 | |
| Sodium | 10 | 12 | | 0-30 | 0-30 | | 10-30 | | | |
| tungstate | | | | | | | | | | |
| Ammonium | | | 10 | | | | | 10-30 | | 10-30 |
| tungstate | | | | | | | | | | |
| Tungsten | | | | | | 13.5-70 | | | | |
| phosphoric | | | | | | | | | | |
| acid | | | | | | | | | | |
| (TMA)₂WO₄ | | | | | | | | | | 10-30 |
| Boric acid | | | | 31 | 31 | | | | | |
| Sodium citrate | 84.5 | 30 | 80 | 130 | 130 | | 20-80 | | | |
| Ammonium | | | | | | | | | | 25-100 |
| citrate | | | | | | | | | | |
| (TMA)₃C₆H₄O₇ | | | | | | | | 20-80 | 20-80 | |
| dihydrate | | | | | | | | | | |
| Ammonium | 50 | | | | | | | | | |
| chloride | | | | | | | | | | |
| Ammonium | | | | | | | | | | |
| sulfate | | | | | | | | | | |
| Sodium borate | | 4 | | | | | | | | |
| decahydrate | | | | | | | | | | |
| Rhodafac 610 | 0.05 | | 0.05 | 0.05 | 0.05 | 0.05 | 0.5 | 0.5 | 0.5 | |
| pH | 9.5 | 8.3-8.7 | | 7.5-9.0 | 9 | 8.9-9.0 | ?? | ?? | ?? | 8-10 |
| pH adjustment | NaOH/KOH | | | | | | ?? | ?? | ?? | TMAH |
| Temperature/° C. | 95 | 78-87 | | 75-90 | 85-95 | 90-95 | ?? | ?? | ?? | 60-80 |

1* 5,695,810 12/1997 Dubin et al.
2** 4,231,813 11/1980 Carlin
3*** 6,165,902 12/2000 Pramanick et al.
^{λ}Yosi Shacham-Diamand, Y. Sverdlov, N. Petrov: “Electroless Deposition of Thin-Film Cobalt-Tungsten-Phosphorus Layers Using Tungsten Phosphoric Acid (H₃[P(W₃O₁₀)₄]) for ULSI and MEMS Applications” Journal of The Electrochemical Society 148 (3), C162-C167 (2001).
^{1κ}A. Kohn, M. Eizenberg, Y. Shacham-Diamand, Y. Sverdlov: “Characterization of electroless deposited Co (W, P) thin films for encapsulation of copper metallization” Materials Science and Engineering A302, 18-25 (2001).
^{2κ}A. Kohn, M. Eizenberg, Y. Shacham-Diamand, B. Israel, Y. Sverdlov: “Evaluation of electroless deposited Co (W, P) thin films as diffusion barriers for copper metallization” Microelectronic Engineering 55, 297-303 (2001).
^{3κ}Y. Shacham-Diamand, Y. Sverdlov: “Electrochemically deposited thin film alloys for ULSI and MEMS applications” Microelectronic Engineering 50, 525-531 (2000).
^{4κ}Yosi Shacham-Diamand, Barak Israel, Yelena Sverdlov: “The electrical and material properties of MOS capacitors with electrolessly deposited integrated copper gate” Microelectronic Engineering 55, 313-322 (2001).
^{π}Yosi Shacham-Diamand, Sergey Lopatin: “Integrated electroless metallization for ULSI” Electrochimica Acta 44, 3639-3649 (1999).
^{θ}Y. Segawa, H. Horikoshi, H. Ohtorii, K. Tai, N. Komai, S. Sato, S. Takahashi, Y. Ohoka, Z. Yasuda, M. Ishihara, A. Yoshio, T. Nogami: “Manufacturing-ready Selectivity of CoWP Capping on Damascene Copper Interconnects” (2001)

A common disadvantage of all known compositions and processes mentioned in Table 1 is that films deposited from the solutions of the aforementioned compounds contains alkali-metal i.e., of Na and K in various alkali metals in concentrations significantly exceeding 2×10⁻⁴ atomic % (2 ppm). It is well known, however, that high concentrations of Na and K, which has high mobility, is unacceptable for functional layers of semiconductor wafers used in the manufacture of semiconductor devices. More specifically, the detrimental effect of alkali metals is primarily related to their easy penetration into the silicon dioxide and microelectronic components.

Other drawbacks of some of the known solution compositions and processes listed in Table 1 are the following: an increased amount of highly-volatile, contaminating, and toxic components in an electroless deposition solution; relatively noticeable toxicity of some compositions; insufficient anti-corrosive properties of the deposited films; increased amount of ions of precipitation metals with a high degree of oxidation; and non-optimal concentrations of complexing agents required for obtaining deposited films with desired properties.

### SUMMARY OF THE INVENTION

It is an object of the invention to provide an alkali-metal-free solution for electroless deposition. Another object is to form smooth coating films which are free of alkali-metal components. A further object is to provide aforementioned coating films suitable for formation of barrier/capping layers on semiconductor substrates. Another object is to provide a method for forming alkali-metal-free coating films and for manufacturing IC devices at a reduced cost. It is another object to reduce the amount of highly-volatile, contaminating, and toxic components in an electroless deposition solution. It is a further object to provide the aforementioned solution with reduced toxicity. Still another object is improve anti-corrosive properties of the deposited films. Another object is to minimize the amount of ions of precipitation metals with a high degree of oxidation. A further object is to exclude or minimize the use of solutions, which have a tendency to the formation of gels and various other colloidal aggregates that may impair properties of deposited metal films. Still another object of the invention is to use complexing agents in optimal concentrations which improve quality of the deposited films.

An electroless deposition solution of the invention for forming an alkali-metal-free coating on a substrate comprises a first-metal ion source for producing first-metal ions, a pH adjuster in the form of a hydroxide for adjusting the pH of the solution, a reducing agent, which reduces the first-metal ions into the first metal on the substrate, a complexing agent for keeping the first-metal ions in the solution, and a source of ions of a second element for generation of second-metal ions that improve the corrosion resistance of the aforementioned coating.

The method of the invention consists of the following steps: preparing hydroxides of a metal such as Ni and Co by means of a complexing reaction, in which solutions of hydroxides of Ni and Co are obtained by displacing hydroxyl ions OH⁻ beyond the external boundary of ligands of mono- or polydental complexants; preparing a complex composition based on a tungsten oxide WO₃ or a phosphorous tungstic acid, such as H₃[P(W₃O₁₀)₄], as well as on the use of tungsten compounds for improving anti-corrosive properties of the deposited films; mixing the aforementioned solutions of salts of Co, Ni, or W and maintaining under a temperatures within the range of 20° C. to 100° C.; and carrying out deposition from the obtained mixed solution.

The deposited films may be represented, e.g., by Co_{0.9}W_{0.02}P_{0.08}, Co_{0.9}P_{0.1}, Co_{0.96}W_{0.04}B_{0.001} or other compounds suitable, e.g., for the formation of barrier layers for copper interconnects in integrated circuits of semiconductor devices.

### DETAILED DESCRIPTION OF THE INVENTION

According to the invention, electroless plating is carried out in special electroless deposition apparatus disclosed in our earlier U.S. patent application Ser. No. 10/103,015 filed on Mar. 22, 2002. The process is performed by conducting autocatalytic oxidation-reduction reactions on the surface of a semiconductor substrate for deposition of pure metals, such as nickel, cobalt, tungsten, molybdenum, as well as of their accompanying elements such as phosphorus, and/or boron.

Given below is a description of the alkaline-free electroless-deposition solution of the present invention. This solution contains no ammonia, and is suitable to deposit an alkali-metal-free layer on various substrates such as noble metals, noble metal activated metals as well as on nickel, cobalt, or copper.

More specifically, the alkali-metal-free deposition solution of the invention may consist of the following components: (i) a metal ion source which can be practically any soluble cobalt (II) salt; (ii) a quaternary ammonium hydroxide to adjust the pH of the solution; (iii) a reducing agent, which reduces the metal ions in the solution into metals layer on the substrate surface; (iv) one or more complexing agents, which keep the metal ions in the solution; (v) a secondary-element source, which improves the corrosion resistance of the layer; and (vi) buffering agent if needed.

Each of the components listed above will be further considered in more detail.

(i) Metal ion source, which can be practically any soluble cobalt (11) salt. Some most common examples are cobalt sulfate and cobalt chloride. The use of high purity cobalt (II) hydroxide would be even more advisable. This compound is sparingly soluble in water but easily dissolves in presence of complexing agents or acids. With the application of metal hydroxides instead of the commonly used soluble metal salts such as metal sulfate, chloride or nitrate salts the contamination level in the electroless deposited layer can be further minimized. Specifically, the use of sulfate, chloride, or nitrate salts introduces unwanted anions (sulfate, chloride, nitrate) into the bath and undesirably into the deposited layer. It is necessary to note that even though the metal ion can be added as a metal salt of the complexing agent, however this option is not recommended since the replenishment of metal would also mean the unwanted elevation of complexing agent concentration too. It has to be noted that for the satisfactory operation of the bath cobalt (II) hydroxide has to be free-from cobalt (III) ions/hydroxides/oxides since cobalt (III) oxide forms unwanted colloids in the solution which later aggregates and precipitates out from the bulk solutions. Therefore, in the present invention we gave an example using cobalt sulfate as a metal source but also propose use of cobalt hydroxide as source of metal ion.

(ii) Tetra-ammonium hydroxide to adjust the pH of the solution. Tetramethyl, tetraethyl, tetrapropyl, tetrabutyl, methyltriethyl, ethyltrimethyl, benzyltrimethyl, or any other longer alkyl chain ammonium hydroxides are adequate for maintaining the solution pH. It should be noted however that in practice tetrabutyl ammonium hydroxide is generally highest applicable member of the tetralkyl ammonium hydroxide family in electroless deposition since it becomes more difficult to adjust an alkaline pH as the alkyl chain gets longer. This is because the molarity of the most concentrated solution decreases drastically as well as less and less free water will be available to dissolve the bath components in the bath. Nevertheless, the use of tetramethyl ammonium hydroxide is preferred over tetraethyl, tetrapropyl, tetrabutyl ammonium hydroxides since TMAH is chemically more stable at elevated temperature than the longer alkyl chain analogs.

(iii) Reducing agent, which reduces the metal ions in the solution into metals layer on the substrate surface. The preferred reducing agent is hypophosphite, which is introduced into the bath as hypophosphorous acid. The hypophosphite also serves as a source for phosphorous in the deposited layer. Another practically usable reducing agent is dimethylamine borane (DMAB), which may be used as a source of boron for the deposition layer, as well as hydrazine.

(iv) One or more complexing agents, which keep the metal ions in the solution even at pH values where the metal ions otherwise would form insoluble metal hydroxide. Common applicable complexing ions are, but not limited to, citrate, tartrate, glycine, pyrophosphate, EDTA. The complexing agents are introduced into the bath as acids. Specifically, citrate is introduced as citric acid, tartrate as tartaric acid, or pyrophosphate as pyrophosphoric acid. In the current invention citric acid will be used as complexing agent but the use of other complexing agents or their combinations are also possible.

(v) Second metal ion source which improves the corrosion resistance of the layer. This ion is a tungsten (VI) compound generally tungsten (VI) oxide (WO₃) or tungsten phosphoric acid H₃[P(W₃O₁₀)₄], however tungsten in other oxidation states such as V or IV, are also applicable. The aforementioned second metal can be selected from the 4^{th} period of the periodic table, 5^{th} period of the periodic table, and 6^{th} period of the periodic table. The second metal selected from the 4^{th} period of the periodic table is selected from Cr, Ni, Cu, and Zn, said second metal selected from the 5^{th} period of the periodic table is selected from Mo, Tc, Ru, Rh, Pd, Ag, Cd, In, Sn, and Sb, and said second metal selected from the 6^{th} period of the periodic table is selected from W, Re, Os, Ir, Pt, Au, TI, and Bi.

(vi) Buffering agent if needed. Most common compound to buffer solution in the pH range 8 to 10 is boric acid.

If necessary, other non-essential components can also be added to the bath in order to change properties of the deposited film, rate of deposition, solution stability, and to improve resistance to corrosion. Some of these auxiliary components and their functions are the following:

(vii) Alloying promoter, which increases a relative amount of alloying elements in the film and makes the film structure more amorphous. Such components can be represented by complexing agents which form highly stable complexes with cobalt ions. It is recommended that the complex stability of such agents exceeds 10¹⁰. These auxiliary complexing agents have to be used in amount significantly smaller than the primary complexing agents. Other auxiliary components of this group are ethylenediamine tetraacetic acid, N,N,N′-hydroxyethyleneethylenediamine triacetic acid, and other similar compounds known to those skilled in the art.

Tsuda and Ishii (U.S. Pat. No. 4,636,255) showed that the addition of N,N,N′-hydroxyethyleneethylenediamine triacetic acid in ca. 4-12 mmol/l concentration could significantly increase the content of phosphorus in a NiP deposit.

The applicants have also found that the addition of any inorganic phosphorous oxocompounds which contain phosphorus in oxidation states of III or V can significantly change the content of phosphorus in the deposited film in order to provide desirable properties, such as reduced stress, improved resistance to diffusion, and improved crystallinity of the film structure. Examples of these additional compounds are the following: phosphates, phosphates, pyrophosphates, and tungsten phosphoric acid. For example, by using a bath containing 71.5 g/l citric acid monohydrate, 21 ml/l 50 wt. % hypophosphorous acid, 23 g/l cobalt (II) sulfate heptohydrate, 7.2 g/l tungsten (VI) oxide, 31 g/l cobalt (II) sulfate heptahydrate, 7.2 g/l tungsten (VI) oxide, 31 g/l boric acid, as well as an appropriate amount of TMAH to adjust the aqueous solution pH to 9-0.2, one can obtain a CoWP film having phosphorous content of about 10 atomic %. When citric acid is replaced with pyrophosphoric acid as a complexing agent in a 61 g/l concentration, the phosphorous concentration of the film changes from 10 atomic % to 2 atomic %.

(viii) Corrosion inhibitor for substrates, e.g., copper substrates. In order to minimize corrosion of copper in the initial period of deposition, a corrosion inhibitor can be added to the deposition solution. However, these compounds should be added tin the amount not detrimental to the purposes of the present invention. Examples of such corrosion inhibitors are the following: inorganic phosphates, silicates. Long-chain alkyl phosphonic acids, though other compounds can also be used and are known to those skilled in the art.

(ix) Surface-active agents. These agents can be added to the bath in order to reduce surface roughness or to modify grain size in the deposited film. Anionic and/or nonionic surface-active agents are preferable, since cationic agents may significantly hamper the deposition.

(x) Accelerator. In order to alter the rate of deposition without changing the composition of the film, a deposition accelerator can be added to the solution. One such accelerator is a boric acid, though other compounds known in the art can also be used.

For capping/aestivation layer on copper or as a barrier layer for copper one requires a CoWP thickness of 50-300 Angstrom. Thicker film adversely affects the line resistance while thinner CoWP layer may not be enough for the film to function as a aestivation or a barrier layer. Furthermore, the solution should provide a continuous, smooth film and the COWP layer should not contain any pinholes, since these sites can be preferential sites for copper diffusion.

In order to achieve a smoother deposit without using additives the mole ratio of citrate to cobalt should be more than 4 and preferably more than 5 the pH above 9.2 preferably around 10. The mole ratio of cobalt plus tungsten to hypophosphite should be between 0.4 and 0.90, preferably between 0.45 and 0.85 when tungsten (VI) oxide is used as the source of tungsten. When tungsten phosphoric acid used as the tungsten source the cobalt plus tungsten to hypophosphite ratio should be between 1.2 and 2.6, preferably around 1.68. Further improvement in surface smoothness can be achieved by adding polypropylene glycol to the solution in 0.01-0.1 g/l into the solution. While polypropylene glycols with an average molecular weight of up to 10,000 were tested and all of them exhibited improvement on the film quality, the preferred molecular weight was found to be from 400 to 1000 Mr.

Having described the components of the alkali-metal-free electroless deposition solution of the invention, let us consider the steps of the method of the invention based on the use of the aforementioned solution.

The method of the invention comprises three steps, which are described below in more detail. All these steps occur simultaneously.

Hydroxides of a bivalent cobalt [Co(OH)₂, Ni(OH)₂] are slightly-dissociated bases and therefore they are poorly soluble in water. In a general form, a reaction of hydroxides with water can be represented as follows:

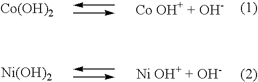

Solubility of these compounds in water is much lower than 0.01%. Therefore, it has been known to those skilled in the art to prepare aqueous solutions from salts of the aforementioned metals, such as CoSO₄ and CoCl₂, rather from their hydroxides. However, the aforementioned salts leads to undesired increase in the contents of anions, such as So₄²⁻. Cal⁻, NO₃⁻, etc., which impair the properties of the deposited films, in particular, resistance of the metal films to corrosion.

Step 1

The authors have found that the aforementioned problems can be solved by dissolving metal hydroxides in the solutions of complexing agents, in which solutions of hydroxides of Ni and Co are obtained by displacing hydroxyl ions OH⁻ beyond the external boundary of ligands of mono- or polydental complexants

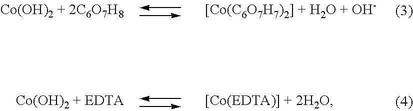

where EDTA is ethylenediaminetetraacetic acid. Cobalt and nickel hydrides are known to be unstable in acidic solutions. Therefore the use of complexing agents as their acids can accelerate dissolving.

Reactions (3) and (4) comprise the first step in the process of the invention and determine the aforementioned autocatalytic process of deposition of metals and phosphorus into films.

As has been mentioned above, one important requirement for obtaining metal film coatings of high purity is elimination of alkali metals from the deposition solutions. In addition to the measures described above, in the present invention this objective is achieved by protecting the deposition solutions from the presence of salts of citric acid, such as (C₆O₇H₇)NH₄ or (C₆O₇H₇)Na. Such a measure makes it possible to reduce concentration of NH₄⁺ ions, which occupy a relatively large volume, and at the same time to exclude ions of alkali metals which may contaminate the final deposited films. In the method of the invention, the salts of alkali metals are replaced by a pure citric acid, which makes it possible to substitute the aforementioned ions by highly mobile and easily removable ions of hydrogen (H⁺).

Step 2

The second step of the process consists of preparing a complex composition based on a tungsten oxide WO₃, phosphorous tungstic acid, such as H₃[P(W₃O₁₀)₄], or tungstic acid, as well as on the use of tungsten compounds with other degrees of oxidation. The presence of tungsten significantly improves anti-corrosive properties of the deposited films. However, the invention excludes the use of alkali-metal salts of tungstic acid, such as Na₂WO₄, since these salts are easily hydrolysable with the formation of Na₂WO₄.2H₂O and are easily soluble in water. This is because the presence of sodium in the deposition solution to some extent limits formation of metal films of high purity required for use in semiconductor industry.

As has been mentioned above, one of the problems associated with selection of components of the working media for electroless deposition is that a tungsten oxide, which has to be used in the process, is practically insoluble in water and acids and therefore cannot be converted directly into an acid, i.e., via a direct reaction with water. However, tungsten trioxides may be converted to soluble tungstate ions, if they are dissolved in highly alkaline solution. This particular property of trioxides was used by the applicants for achieving one of the objects of the invention. The compounds used by applicants for these purposes comprised alkylammonium hydroxides, such as tetramethylammonium hydroxide (CH₄)₄NOH (hereinafter referred to as TMAH), tetraethylammonium hydroxide (C₂H₅)₄NOH (hereinafter referred to as TEAOH), tetrabutylammonium hydroxide (C₄H₉)₄NOH (hereinafter referred to as TBAOH), tetrapropylammonium hydroxide (hereinafter referred to as TPA), methyltriethylammonium hydroxide (CH₄) (C₂H₅)₃NOH (hereinafter referred to as MTEOH), ethyltrimethylammonium hydroxide (CH₄)₃(C₂H₅)NOH (hereinafter referred to as ETMOH), benzyltrimethylammonium hydroxide (C₆H₅)CH₂(CH₄)₃NOH (hereinafter referred to as Triton B), phenyltrimethylammonium hydroxide, methyltripropylammonium hydroxide, and a compound that includes a molecular chain of butyl radicals, such as tetrabutylammonium hydroxide (C₄M₉— (CH₄H₇)ₙ—C₄H₉) 4NOH, which is also known as tetrabutylammonium hydroxide.

The use of TMAH is less desirable in view of its high volatility and toxicity.

It is more preferable to use ethyl-, propyl-, and butylammonium hydroxides which are less volatile and toxic.

In the aforementioned compounds, alkyl radicals should have optimal mobility required for maintaining pH of the medium. The applicants have found that such compounds as TBAOH, TENOH, and TPA may satisfy the requirement of radical mobility, and at the same time do not create obstacles for formation of water-soluble complexes with tungsten trioxides. Heavier alkyls, beginning from pentyls, decrease solubility of the complexes in water. The applicants assume that this phenomenon is associated with electron-density screening which is higher in alkyls of larger dimensions.

Step 3

In the third step, for deposition of coating films, the aforementioned solutions of salts of Co, Ni, or W are mixed and maintained under a temperatures within the range of 20° C. to 100° C. The deposited films may be represented, e.g., by Co_{0.9}W_{0.02}P_{0.08}, Co_{0.9}P_{0.1}, Co_{0.96}W_{0.04} B_{0.001} or other compounds suitable, e.g., for the formation of barrier layers for copper interconnects in integrated circuits of semiconductor devices.

The invention will be further described with reference to Practical Examples. In the following examples the content of elements of the coating films obtained by means of ion microprobe known as SIMS (Secondary Ion Mass Spectrometry technique), in which a high energy primary ion beam is directed at an area of the sample whose composition is to be determined. The values obtained by the SIMS method will be given in atomic percents.

### PRACTICAL EXAMPLE 1

Five deposition solutions, each having a volume of 1 liter, were prepared by mixing the following components with an increase in the content of each component: 50 g to 100 g of citric acid monohydrate (C₆O₇H₈xH₂O) with 10 g difference between the subsequent solutions; 15 ml to 27 ml of a 50 wt. % hypophosphorous acid (H₃PO₂) with 3 ml difference between the subsequent hypophosphorous acids; 18 g to 26 g of cobalt sulfate heptahydrate (CoSO₄x7H₂O) with 2 g difference between subsequent cobalt sulfate heptahydrates; 24 g to 36 g of boric acid (H₃BO₃ with 3 g difference between the subsequent boric acids; 11 g to 16 g of tungsten (VI) oxide (WO₃) with 1.5 g difference between the subsequent; and an appropriate amount of TMAH for each solution required to reach an appropriate alkaline pH. The deposition was performed at a bath temperature of 75° C. The deposition rates were within the range of 180 to 220 Angstrom/min. The composition of the obtained coating film was determined with the use of SIMS showed that the film contained 5-6 atomic % phosphorous, 7.0-7.5 atomic % tungsten, and cobalt as balance. Furthermore, the results of the SIMS analysis showed that the content of Na and K did not exceed 2×10⁻⁴ atomic % (2 ppm).

Analysis showed that films deposited from the electroless deposition solution prepared in Practical Example 1 had high anti-corrosive properties.

### PRACTICAL EXAMPLE 2

Five deposition solutions, each having a volume of 1 liter, were prepared by mixing the following components with an increase in the content of each component: 50 g to 90 g of citric acid monohydrate (C₆O₇H₈xH₂O) with 10 g difference between the subsequent solutions; 15 ml to 27 ml of a 50 wt. % hypophosphorous acid (H₃PO₂) with 3 ml difference between the subsequent hypophosphorous acids; 18 g to 26 g of cobalt sulfate heptahydrate (CoSO₄x7H₂O) with 2 g difference between subsequent cobalt sulfate heptahydrates; 24 g to 36 g of boric acid (H₃BO₃ with 3 g difference between the subsequent boric acids; 11 g to 16 g of tungsten (VI) oxide (WO₃) with 1.5 g difference between the subsequent; and an appropriate amount of TBAOH for each solution required to reach an appropriate alkaline pH of 9.3 to 9.7. The deposition was performed at a bath temperature of 75° C. The deposition rates were within the range of 220 to 260 Angstrom/min. The composition of the obtained coating film was determined with the use of SIMS showed that the film contained 6.5 to 7.5 atomic % phosphorous, 3.5 to 4.0 atomic % tungsten, and cobalt as balance. Furthermore, the results of the SIMS analysis showed that the content of Na and K did not exceed 2×10⁻⁴ atomic % (2 ppm).

It can also be seen that the electroless deposition solution prepared in Practical Example possessed lower toxicity than a majority of the known deposition solutions.

### PRACTICAL EXAMPLE 3

Five deposition solutions, each having a volume of 1 liter, were prepared by mixing the following components with an increase in the content of each component: 50 g to 90 g of citric acid monohydrate (C₆O₇H₈xH₂O) with 10 g difference between the subsequent solutions; 15 ml to 27 ml of a 50 wt. % hypophosphorous acid (H₃PO₂) with 3 ml difference between the subsequent hypophosphorous acids; 18 g to 26 g of cobalt sulfate heptahydrate (CoSO₄x7H₂O) with 2 g difference between subsequent cobalt sulfate heptahydrates; 24 g to 36 g of boric acid (H₃BO₃ with 3 g difference between the subsequent boric acids; 11 g to 16 g of tungsten (VI) oxide (WO₃) with 1.5 g difference between the subsequent; and an appropriate amount of TEAOH for each solution required to reach an appropriate alkaline pH of 9.3 to 9.7. The deposition was performed at a bath temperature of 75° C. The rates of deposition were within the range of 80 to 140 Angstrom/min. The composition of the obtained coating film was determined with the use of SIMS showed that the film contained 9.5 to 10.0 atomic % phosphorous, 0.5 to 1.0 atomic % tungsten, and cobalt as balance. Furthermore, the results of the SIMS analysis showed that the content of Na and K did not exceed 2×10⁻⁴ atomic % (2 ppm).

Analysis showed that, along with a reduced toxicity of the solution and high anti-corrosive properties of the deposited films, the deposited films has a very low concentration of metals prone to oxidation.

### PRACTICAL EXAMPLE 4

Five deposition solutions, each having a volume of 1 liter, were prepared by mixing the following components with an increase in the content of each component: 60 g to 100 g of citric acid monohydrate (C₆O₇H₈xH₂O) with 10 g difference between the subsequent solutions; 30 ml to 42 ml of a 50 wt. % hypophosphorous acid (H₃PO₂) with 3 ml difference between the subsequent hypophosphorous acids; 16 g to 24 g of cobalt sulfate heptahydrate (CoSO₄x7H₂O) with 2 g difference between subsequent cobalt sulfate heptahydrates; 9.5 g to 14.5 g of tungsten (VI) oxide (WO₃) with 1.5 g difference between the subsequent; and an appropriate amount of TPA for each solution required to reach an appropriate alkaline pH of 10.1 to 10.5. The deposition was performed for each solution at three different bath temperatures of 55° C., 65° C., and 75° C. The rates of deposition were within the range of 90 to 260 Angstrom/min. The composition of the obtained coating film was determined with the use of SIMS showed that the film contained 6.5 to 7.5 atomic % phosphorous, 3.5 to 4.0 atomic % tungsten, and cobalt as balance. Furthermore, the results of the SIMS analysis showed that the content of Na and K did not exceed 2×10⁻⁴ atomic % (2 ppm).

Improved properties of the obtained films showed that complexing agents had optimal concentrations in the deposition solution.

Thus it has been shown that the invention provides an alkali-metal-free solution for electroless deposition, makes it possible to reduce the amount of highly-volatile, contaminating, and toxic components in an electroless deposition solution, provides aforementioned solutions with reduced toxicity, improves anti-corrosive properties of the deposited films, minimizes the amount of ions of precipitation metals with a high degree of oxidation, excludes or minimizes the use of solutions, which have a tendency to the formation of gels and various other colloidal aggregates that may impair properties of deposited metal films, makes it possible to use complexing agents in optimal concentrations which improve quality of the deposited films, allows to form smooth coating films which are free of alkali-metal components, provides aforementioned coating films suitable for formation of barrier/capping layers on semiconductor substrates, and provides a method for forming alkali-metal-free coating films and for manufacturing IC devices at a reduced cost.

The invention has been shown and described with reference to specific embodiments, which should be construed only as examples and do not limit the scope of practical applications of the invention. Therefore any changes and modifications in technological processes, components and their concentrations in the solutions are possible, provided these changes and modifications do not depart from the scope of the patent claims.

1. An electroless deposition solution for forming an alkali-metal-free coating on a substrate on the basis of substances selected from metals of the VIII group of the 4^{th} period of the periodic table of element, compositions of said metals with elements selected from the VIIB and VIIB groups of the periodic table, the VIII group of the 5^{th} period of the periodic table, and phosphorus, said composition comprising:
(i) a first-metal ion source for producing ions of a first metal;
(ii) a pH adjuster in the form of a quaternary ammonium hydroxide for adjusting the pH of said solution;
(iii) a reducing agent, which reduces said first-metal ions into first metals on said substrate;
(iv) at least one complexing agent, for keeping said first-metal ions in said electroless deposition solution;
(v) a second-element ion source for generation of ions of a second metal that improve the corrosion resistance of said alkali-metal-free coating.

2. The electroless deposition solution of claim 1, wherein said metals of said VIII group of the 5^{th} period of the periodic table comprise cobalt and nickel.

3. The electroless deposition solution of claim 1, wherein said first-metal ion source (i) is a soluble salt of a metal (II) from VIII group of the 4^{th} period of the periodic table of elements, said soluble salt being selected from a group consisting of a metal sulfate, metal chloride, and metal hydroxide, which are free from ions of higher ionization state (III) of said metal (II) from VIII group of the 4^{th} period of the periodic table.

4. The electroless deposition solution of claim 1, wherein said quaternary-ammonium hydroxide (ii) for adjusting the pH of the solution is selected from the group consisting of: tetramethylammonium hydroxide, tetraethylammonium hydroxide, tetrapropylammonium hydroxide, tetrabutylammonium hydroxide, methyltriethylammonium hydroxide, ethyltrimethylammonium hydroxide, benzyltrimethylammonium hydroxide, phenyltrimethylammonium hydroxide, and methyltripropylammonium hydroxide, and any compound of formula R₁R₂R₃R₄NOH, where R₁, R₂, R₃, R₄ can be the same or different and can be represented by alkyl, aryl, or alkylaryl groups, where said alkyl groups can be represented by the following general formula CₙH₂ₙ₊₁ and where aryl and alkylaryl groups are selected from benzyl and benzylalkyl of C₆H₅ and C₆H₅—CₙH₂n+₁, respectively.

5. The electroless deposition solution of claim 1, wherein said quaternary-ammonium hydroxide (ii) for adjusting the pH of the solution is selected from the group consisting of: tetramethylammonium hydroxide, tetraethylammonium hydroxide, tetrapropylammonium hydroxide, and tetrabutylammonium hydroxide.

6. The electroless deposition solution of claim 1, wherein said reducing agent (iii), which reduces the metal ions in the solution into metals layer on said substrate is selected from the group consisting of hypophosphate, alkyl, dialkyl, trialkyl amine boranes of the following general formula: R₁R₂R₃NH₃₋ₙBH₃, where R₁, R₂, R₃ can be the same or different alkyl groups, n is the number of alkyl groups attached to said amine boranes, where n can be 0, 1, 2, and 3, as well as dymethyl borane, and hydrazine.

7. The electroless deposition solution of claim 1, wherein said reducing agent (iii), which reduces the metal ions in the solution into metals layer on said substrate is selected from the group consisting of hypophosphate, hydrazine, dimethylamine borane.

8. The electroless deposition solution of claim 3, wherein said reducing agent (iii), which reduces the metal ions in the solution into metals layer on said substrate is selected from the group consisting of hypophosphite dimethylamine borane.

9. The electroless deposition solution of claim 4, wherein said reducing agent (iii), which reduces the metal ions in the solution into metals layer on said substrate is selected from the group consisting of hypophosphite dimethylamine borane.

10. The electroless deposition solution of claim 6, wherein said hypophospite comprises a source of phosphorous in said alkali-metal free coating and is introduced into said solution in the form of a compound selected from the group consisting of hypophosphorous acid, an alkali-metal-free salt of hypophosphorous acid, and a complex of a hypophosphoric acid.

11. The electroless deposition solution of claim 7, wherein said reducing agent (iii), which reduces the metal ions in the solution into metals layer on said substrate is selected from the group consisting of hypophosphite dimethylamine borane.

12. The electroless deposition solution of claim 8, wherein said reducing agent (iii), which reduces the metal ions in the solution into metals layer on said substrate is selected from the group consisting of hypophosphite dimethylamine borane.

13. The electroless deposition solution of claim 9, wherein said reducing agent (iii), which reduces the metal ions in the solution into metals layer on said substrate is selected from the group consisting of hypophosphite dimethylamine borane

14. The electroless deposition solution of claim 1, wherein said at least one complexing agent (iv) is selected from the group consisting of citrate, tartrate, glycine, pyrophosphate, and ethylenediaminetetraacetic acid, said complexing agents being introduced into said electroless deposition solution as acids.

15. The electroless deposition solution of claim 6, wherein said at least one complexing agent (iv) is selected from the group consisting of citrate, tartrate, glycine, pyrophosphate, and ethylenediaminetetraacetic acid, said complexing agents being introduced into said electroless deposition solution as acids.

16. The electroless deposition solution of claim 7 wherein said at least one complexing agent (iv) is selected from the group consisting of citrate, tartrate, glycine, pyrophosphate, and ethylenediaminetetraacetic acid, said complexing agents being introduced into said electroless deposition solution as acids.

17. The electroless deposition solution of claim 8, wherein said at least one complexing agent (iv) is selected from the group consisting of citrate, tartrate, glycine, pyrophosphate, and ethylenediaminetetraacetic acid, said complexing agents being introduced into said electroless deposition solution as acids.

18. The electroless deposition solution of claim 9, wherein said at least one complexing agent (iv) is selected from the group consisting of citrate, tartrate, glycine, pyrophosphate, and ethylenediaminetetraacetic acid, said complexing agents being introduced into said electroless deposition solution as acids.

19. The electroless deposition solution of claim 14, wherein said acids are selected from the group consisting of citric acid, tartaric acid, and pyrophosphoric acid.

20. The electroless deposition solution of claim 15, wherein said acids are selected from the group consisting of citric acid, tartaric acid, and pyrophosphoric acid.

21. The electroless deposition solution of claim 16, wherein said acids are selected from the group consisting of citric acid, tartaric acid, and pyrophosphoric acid.

22. The electroless deposition solution of claim 17, wherein said acids are selected from the group consisting of citric acid, tartaric acid, and pyrophosphoric acid.

23. The electroless deposition solution of claim 18, wherein said acids are selected from the group consisting of citric acid, tartaric acid, and pyrophosphoric acid.

24. The electroless deposition solution of claim 19, wherein said acids are selected from the group consisting of citric acid, tartaric acid, and pyrophosphoric acid.

25. The electroless deposition solution of claim 1, wherein said second-metal ion source is selected from the group consisting of tungsten oxides, tungsten phosphoric acids, and tungstic acid.

26. The electroless deposition solution of claim 2, wherein said second-metal ion source is selected from the group consisting of tungsten oxides, tungsten phosphoric acids, and tungstic acid.

27. The electroless deposition solution of claim 3, wherein said second-metal ion source is selected from the group consisting of tungsten oxides, tungsten phosphoric acids, and tungstic acid.

28. The electroless deposition solution of claim 4, wherein said second-metal ion source is selected from the group consisting of tungsten oxides, tungsten phosphoric acids, and tungstic acid.

29. The electroless deposition solution of claim 5, wherein said second-metal ion source is selected from the group consisting of tungsten oxides, tungsten phosphoric acids, and tungstic acid.

30. The electroless deposition solution of claim 6, wherein said second-metal ion source is selected from the group consisting of tungsten oxides, tungsten phosphoric acids, and tungstic acid.

31. The electroless deposition solution of claim 7, wherein said second-metal ion source is selected from the group consisting of tungsten oxides, tungsten phosphoric acids, and tungstic acid.

32. The electroless deposition solution of claim 1, wherein said second metal is selected from the 4^{th} period of the periodic table, 5^{th} period of the periodic table, and 6^{th} period of the periodic table.

33. The electroless deposition solution of claim 32, wherein said second metal selected from the 4^{th} period of the periodic table is selected from Cr, Ni, Cu, and Zn, said second metal selected from the 5^{th} period of the periodic table is selected from Mo, Tc, Ru, Rh, Pd, Ag, Cd, In, Sn, and Sb, and said second metal selected from the 6^{th} period of the periodic table is selected from W, Re, Os, Ir, Pt, Au, Tl, and Bi.

34. The electroless deposition solution of claim 1, further comprising a buffering agent.

35. The electroless deposition solution of claim 30, wherein said buffering agent is a boric acid solution for maintaining pH of said electroless deposition solution within the range of 8 to 10.

36. The electroless deposition solution of claim 2, further comprising a buffering agent.

37. The electroless deposition solution of claim 36, wherein said buffering agent is a boric acid solution for maintaining pH of said electroless deposition solution within the range of 8 to 10.

38. The electroless deposition solution of claim 3, further comprising a buffering agent.

39. The electroless deposition solution of claim 38, wherein said buffering agent is a boric acid solution for maintaining pH of said electroless deposition solution within the range of 8 to 10.

40. The electroless deposition solution of claim 5, wherein said alkaline-free coating is a cobalt tungsten phosphorous alloy film having a phosphorous content of 2% to 14% and a tungsten content of 0.5% to 5%, said electroless deposition solution comprising: cobalt ions, tungsten ions, a hypophosphite reducing agent for said cobalt and tungsten ions, a citric acid as complexing agent for said cobalt and tungsten ions, and a pH adjustor.

41. A method for electroless deposition of a coating free of alkali-metals onto a substrate comprising:
using complexing reactions, in which solutions of hydroxides of Ni and Co are obtained by displacing hydroxyl ions OH⁻ beyond the external boundary of ligands of mono- or polydental complexants in accordance with equations (1) and (2): 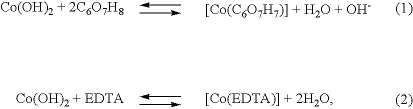
where EDTA is ethylenediaminetetraacetic acid;
preparing a complex composition based on compound selected from the group consisting of a tungsten oxide WO₃, a phosphorous tungstic acid, TMAH, citric acid, boric acid;
mixing said solution with appropriate additives, while maintaining said solution under a temperatures within the range of 20° C. to 120° C.; and
depositing an alkaline-free coating on said substrate.

42. The method of claim 41, wherein said alkaline-free coating comprises a barrier layer for the formation of copper interconnects in integrated circuits of semiconductor devices and is formed from a material selected from the group consisting of Cu_{0.9}W_{0.02}P_{0.08}, Cu_{0.9}P_{0.1} Co_{0.96}W_{0.0436}, B_{0.004}, C_{0.9}MO_{0.02}P_{0.08}.
